(19) United States
(12) Patent Application Publication
(10) Pub. No.: US 2009/0266579 A1
(43) Pub. Date: Oct. 29, 2009

(54) INTERCONNECTOR

(75) Inventors: Eckehard HOFMULLER, Oslo (NO); Erik Sauar, Oslo (NO)

Correspondence Address: BIRCH STEWART KOLASCH & BIRCH, PO BOX 747, FALLS CHURCH, VA, 22040-0747, US

(73) Assignee: REC Solar AS, Sandvika (NO)

(21) Appl. No.: 12/418,312

(22) Filed: Apr. 3, 2009

Related U.S. Application Data
(60) Provisional application No. 61/042,280, filed on Apr. 4, 2008.

(30) Foreign Application Priority Data
Apr. 4, 2008 (GB) 0806216.8

(51) Int. Cl. H01B 5/00

(52) U.S. Cl. 174/126.1

(57) ABSTRACT

The present invention provides a solar module with inter-connectors with improved flexibility. The flexibility is achieved by placing a fabric between the solar elements. The fabric is conductive and may be soldered or welded to the solar elements.

### INTRODUCTION

The present invention provides a solution for the interconnectors between solar cells in solar modules.

### PRIOR ART

Usually, solar cells are electrically connected, and combined into “modules”, or solar panels. Typical solar modules have a sheet of glass on the front, and a resin encapsulation behind to keep the semiconductor wafers safe from the element such as rain, hail, etc., and give protection against corrosion. Solar cells are usually connected in series in modules, so that their voltages add. This interconnection is provided by a metallic interconnector attached on two adjacent solar cells.

Due to repeated thermal expansion due to temperature variations, the solar cells and interconnectors are exposed to stress which may lead to fatigue and ultimately to operation failure.

Interconnectors of prior art comprise strips from copper with a tin containing solder coating, such as provided by WO2005/013322A, where each interconnector strip is curved to provide strain relief.

One solution was suggested in DE-102006019638, where the interconnectors are elastic and consist of string carrier elements which are formed as plates.

Another solution is provided in WO2005/122282, where a shield is placed as interconnector between the solar cells. As one embodiment there are provided slits which are intended to give strain relief. DE-102005058170 provides a solder interconnector which comprises a metal element with the benefit of a cover layer on the front side.

For voltaic devices as in DE-10032286, there have been suggested textile materials in combination with titanium oxide which constitute the solar element/cell itself. Thereby there is sought to provide devices for transformation of solar energy into electric energy which may be integrated into utility articles.

### OBJECTIVE

There is sought to find a solution to provide interconnectors which are flexible to compensate expansion and contraction resulting from thermal expansion such that mechanical loads onto the solar cells are minimized.

Further, the disadvantages with the interconnectors in use today are sought to be overcome by the present invention as described by the enclosed description and patent claims.

### DESCRIPTION OF THE INVENTION

A solar module of prior art comprises a light receiving structure having a sufficiently transparent front cover and a plurality of active elements placed behind said front cover and a plurality of interconnectors comprising at least one electric conductive layer and each interconnecting minimum two adjacent said active elements.

The present invention provides a solar module with interconnectors which comprise conductive fabric and where the interconnectors are placed in such a way between two adjacent solar elements that it provides electric connection between both elements. Thus the placement may be in between the solar elements and partly over the surface of the solar elements where the electric contacts of the elements are located. The important aspect is that the fabric is placed in such a manner that a flexible interconnection is achieved. The person skilled in the art will appreciate that different types of placement are possible.

Standard technology for the electrical and mechanical connection of the interconnector to the solar elements is soldering. This technology can also be used to connect the metallic fabric onto the solar elements. The electrical contact areas of the solar elements which are intended for soldering have to be solderable. Different solder technologies may be applied like for example soft-soldering, brazing or ultrasonic soldering. In addition different methods to achieve connection are possible. One example is welding; here the material of the interconnector and of the contact area of the solar elements is intended to be weldable, as e.g. aluminium. Gluing the metallic fabric to the contact areas by using adhesives is another possible connection technology. The adhesives are preferably conductive.

Fabric is here defined to be a piece with continuous string or wire, as typical in weave or weaving or knit or cloth. The fabric may therefore have meshes, stitches or may be especially composed from chain and shoot as in a weave. The fabric may be made by weaving or knitting. The fabric has the ability to react flexible on thermal influences and thus minimizes mechanical loads onto the connection areas of the solar elements in situations of thermal stresses.

Preferably only the wires of the fabric running directly between two cells are fix connected to the cells while the wires going parallel to the cell edge are not. The wires running parallel to the cell edges are only important to improve the redundancy of the electrical connection and to keep the integrity of the interconnection piece for better handling.

The fabric is made from conductive material. The fabric of the present invention may comprise elements of the group Cu, Al or Ag, but it may as well comprise these elements and contain other substances as well. The contents of the said elements may be in the range of 50-100%, 70-100%, or 90-100%. The material composition should be chosen in order to achieve the necessary conductivity of the interconnector and to provide the needed surface quality for the chosen connection technology. Normally the best electrical conductivity is provided by pure Ag metal (>60*10⁶ S/m), however from a cost perspective or other reasons, metals like Cu (58*10⁶ S/m) or Al (38*10⁶ S/m) may be preferred.

The fabric can comprise one or several coating(s). The purpose of the coating may be to ease the soldering of the interconnector to the solar element or to protect the fabric from corrosion. The fabric may be also coated with a reflective layer in order to redirect incident light to adjacent solar cells, whereby the coating is placed on top of the fabric towards the incident light. In one aspect this could be a white paint which scatters the incident light. A part of the scattered light will reach the upper surface of the front glass under such an angle, that it will be redirected to the adjacent solar cell by means of total internal reflection. In another aspect the structure of the upper surface of the interconnector of the present invention can comprise mirror coated grooves for example as described in PCT-2006000489 from REC. With an optimised opening angle of the grooves virtually all direct incident light may be reflected to the adjacent solar cells.

The interconnector may be part of a multi-layer structure. As one example the multi-layer structure may comprise a reflective layer on the upper side of the fabric with an intermediate flexible adhesive layer to fix the reflective layer onto the fabric. The person skilled in the art can tailor the interconnectors of the present invention. When composing a multi-layer structure it is important to verify that the flexibility of the interconnector is maintained.

When the interconnector of the present invention is built up of several layers or is coated, the coating(s) or layer(s) may contain colouring matters as for example pigments in a polymer coating. By this way a more homogenous appearance of the solar module may be achieved.

The density of the fabric can be adapted to the thickness of the continuous strings. The density of the fabric is regarded to be the amount of strings versus the aperture as is regularly defined in textile engineering. Beside the thickness of the continuous strings there are many different types of weaves and apertures by which the density may be defined more tightly or more loosely. The density may be tight in order to achieve a high conductivity. In another embodiment the density can be loose whereby the wire ends of the fabric are separable and can be easily connected directly to the solar elements. The person skilled in the art can easily test out different fabrics with varying properties and adapt them to the type and concept of the solar element.

The solar elements can be crystalline Si solar elements in solar modules. In the term of the present patent application, the term solar module comprises a plurality of single solar element which has the ability to transform solar beams into energy and which is connected to each other by interconnectors. The wording solar elements and solar cell are used identically.

In one aspect the interconnection between the solar elements and the interconnectors is achieved directly. In another aspect a tab or other connecting device such as a strip, is used for interconnection. The tab provides a transmission area between the solar element and the interconnector. The tab is made from a conductive material and may have a rectangular or string or T-form or H-form or any other suitable form. Such contact tabs may improve the soldering process significantly since only few well defined solder spots (i.e. six) per interconnector may be processed.

Interconnectors according to the present invention can be designed to have many connecting places which connect the interconnector to the solar elements. Connecting places are provided by the wires of the conductive fabric. The advantage of these interconnectors of the present invention is that they provide high redundancy in the event of failure of one of the interconnection places. Thereby longevity is increased, whereby improving the economy and efficiency of the solar module.

Solar modules are typically applied in outdoor conditions and thus exposed to numerous thermal cycles over their lifetime due to the day/night temperature difference. This results into continuous expansion and shrinkage of the solar cells and interconnectors which leads again to fatigue effects on the connection points between cells and interconnectors. The interconnectors of the present invention provide an interconnection between the solar cells that behaves flexible and/or elastic when applied to tensile or compressive strains such as resulting from the thermal expansion of the solar cells and interconnectors. The interconnectors can be imagined as strain-absorbers between adjacent solar elements and fatigue effects on the connection points between cells and interconnectors may be minimized.

By using interconnectors of the present invention comprising an upper reflective layer it is possible to increase the gap between the solar cells and widening the usable area of the reflective interconnector. Thereby a significant amount of silicon solar cells may be saved per solar module.

When incorporating colouring matters to the interconnectors of the present invention, the appearance of the solar modules can be made appealing or homogeneous and can be optimized to the intended use and placement. Thereby the invention provides solar modules with different design possibilities which may enhance the aesthetic appearance of solar modules of prior art. As one possibility the solar modules comprising the interconnectors of the present invention may have the same colour as the solar cells whereby the solar module will appear as homogenous and interesting for visible applications as for example on building facades. By providing an appealing design, the solar modules comprising interconnectors according to the present invention may lead to increase the range of applicability of solar modules in general, such that the exploitation of solar energy will increase and give an environmental effect since more polluting energy sources may be avoided. Thereby the present invention may also be regarded as to have environmental benefits which are beneficial for the world.

### EXAMPLES

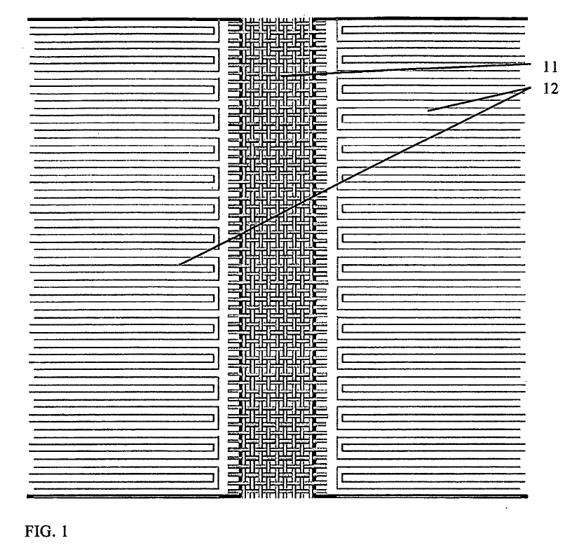

FIG. 1 shows one embodiment of an interconnector 11 according to the present invention. The interconnector 11 is placed between the solar cells 12. The interconnector 11 is a stripe of metal cloth wires positioned on the back surface of two solar cells 12 in such way, that it electrically connects the positive contact of one cell to the negative contact of the other one. Base material of the metal cloth may be wires of Cu with a thin Sn or solder coating. The Cu wires may have a diameter of ca. 0.1 mm to 0.2 mm and a wire pitch of double the wire diameter to provide a good conductivity of the interconnector while maintaining a high mechanical flexibility of the cloth. As an example an Cu cloth stripe for a standard solar cell with 156×156 mm² format with a wire diameter of 0.12 mm and a pitch of 0.24 mm would have a resistivity of ca. 20 μΩ/mm. For comparison, the resistivity of three parallel Cu ribbons of 0.11 mm height and 2 mm width, as they are widely used today for crystalline solar cell interconnection, is ca. 27 μΩ/mm.

Connection to the cells may be done by soldering the wires to the metallized contacts of the cells.

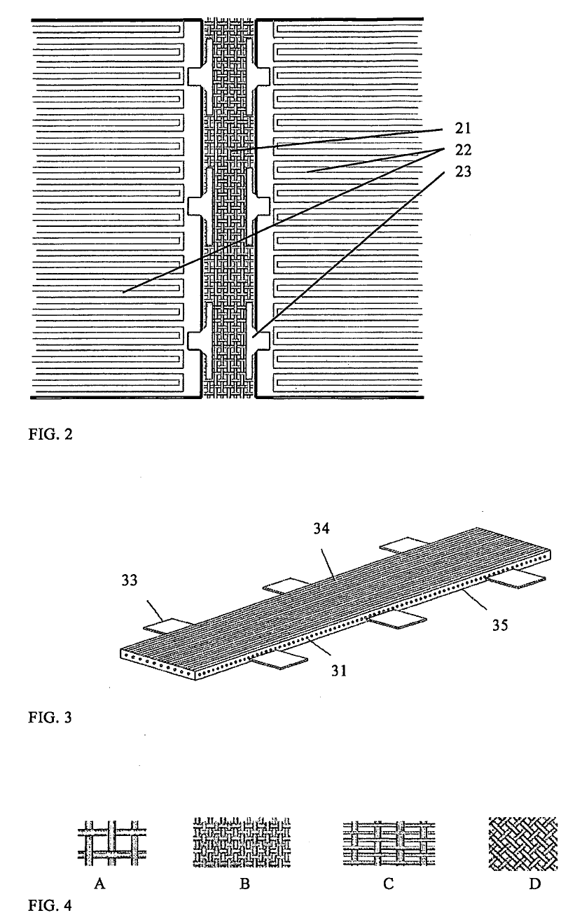

FIG. 2 shows another embodiment of an interconnector 21 of the present invention. This interconnector 21 is a stripe of metal cloth wires and is connected to a set of metal contact tabs 23 onto front side and back side of the cloth stripe by means of welding. The interconnector 21 is positioned on the back surface between two adjacent solar cells 22 and the contact tabs 23 electrical connected the interconnector 21 to the cells 22 by soldering.

FIG. 3 shows a third embodiment of an interconnector 31 of the present invention. This interconnector is part of a multilayer structure. On top of the interconnector 31 made from fabric with metal cloth wires, a reflective structure 34 is placed. This may be a polymer film with preformed and mirror coated micro grooves. The parallel grooves may have an opening angle of 110° to 130° and a pitch of 50 μm to 200 μm. Mirror coating may be provided by evaporation or sputtering of high reflective metals such as Al or Ag. The reflective structured film 34 is fixed onto the fabric by a layer of a polymer moulding 35 which also encapsulated the fabric itself. As polymer moulding 35 EVA, a widely used encapsulant for solar cells in solar modules, may be used to fix the film onto the interconnector. This can by done by placing a film of not cross linked EVA between the interconnector 31 and the reflector film 34 and pressing this stack together under heat. During this process the EVA will melt and float around the interconnector 31 as well as stick to the reflector film 34. The cross linking of the EVA may then occur later during the lamination process at the production of the solar module, as an alternative a separate cross-linking stage of prior art can be applied. The elasticity of the EVA allows also after the lamination a flexible reaction of the interconnector. Contact tabs 33 is placed on the longitudinal edge of the interconnector and is welded to the interconnector 31 before application of the other layers.

FIG. 4 shows a variety of different metal cloth designs. A and B show two different plain weaves with square aperture and different wire diameters and pitches.

A shows a loose density, and B shows a tight density. C shows a cloth of broad rectangular aperture with different wire diameters for warp and weft. Also the angle of the wires may be varied as shown in D. With these parameters the cloth may be optimised according to the application in terms of electrical resistance and mechanical flexibility.

1. A flexible interconnector connecting solar elements, comprising a conductive fabric with a continuous string or wire that is electrically connected to two adjacent solar elements, characterized in that said fabric is covered by a reflective coating.

2. An interconnector according to claim 1, characterized in that said coating is on top of the fabric facing incident light.

3. An interconnector according to claim 1, characterized in that the said fabric is part of a multilayer structure.

4. An interconnector according to claims 1, characterized in that one or several layer(s) or coating(s) comprise grooves and/or mirror coating.

5. An interconnector according to claims 1, characterized in that one or several layer(s) or coating(s) comprises colouring matter.

6. An interconnector according to claim 1, characterized in that only wires of the fabric running directly between two cells are connected to the cells.

7. An interconnector according to claim 1, characterized in that said fabric comprises metal solder tabs.

8. An interconnector according to claim 7, characterized in that said metal solder tabs are welded on to the fabric.

9. An interconnector according to claim 1, characterized in that said fabric is made of conductive metal wires such as Cu, Ag or Al.

10. An interconnector according to claim 1, characterized in that said fabric is a weave or knitting.

11. An interconnector according to claim 1, characterized in that the electrical connection between interconnector and solar cells is a soldering connection.
